(19) United States
(12) Patent Application Publication
(10) Pub. No.: US 2007/0160050 A1
(43) Pub. Date: Jul. 12, 2007

(54) Diagnostic mechanism for Layer 2 and Layer 3 networks

(75) Inventor: Zheng Wang, San Mateo, CA (US)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Broadcom Corporation

(21) Appl. No.: 11/410,885

(22) Filed: Apr. 26, 2006

Related U.S. Application Data
(60) Provisional application No. 60/757,043, filed on Jan. 9, 2006.

(51) Int. Cl. H04L 12/56

(52) U.S. Cl. 370/392; 370/401

(57) ABSTRACT

A diagnostic apparatus and method for a network includes a sender configuring a time to live (TTL) field in a packet to include an integer value greater than zero, configuring and extending an Internet Control Message Protocol (ICMP) message to include a Media Access Control (MAC) address and an Internet Protocol (IP) address, and transmitting the ICMP message. A switch corresponding to the MAC address is configured to add diagnostic information to the ICMP message. A router corresponding to the IP address is configured to add diagnostic information to the ICMP message. A receiver is configured to receive the packet.

### BACKGROUND OF THE INVENTION

1. Field of the Invention

The present invention provides a diagnostic method allowing detection of transmission or congestion problems in a Layer 2 network and a Layer 3 network using an extended ICMP message.

2. Description of the Related Art

Telecommunication networks such as voice, data, and video networks have conventionally been customized for the type of traffic each is to transport. For example, voice traffic is very latency sensitive but quality is less important, so voice networks are designed to transport voice traffic with limited latency. Traditional data traffic, such as, e.g., a spreadsheet, on the other hand is not latency sensitive, but error-free delivery is required. Conventional telecommunications networks use circuit switching to achieve acceptable end user quality of service (QoS). With the advent of new packet switching high bandwidth data networks, different types of traffic can be transported over a data network. Specifically, convergence of separate voice, data and video networks into a single broadband telecommunications network is enabled.

Additionally, in conventional networks common logical components exhibit different characteristics depending on the specific application context. For example, in the related art applications, network nodes are classified into routers and end hosts. However, related art applications may further differentiate between server nodes and client nodes, and it is very difficult for the related art system to accommodate such an additional requirement.

However, in conventional network diagnostic applications, the diagnostic functionalities cannot be flexibly applied to different networks exhibiting different characteristics. For instance, one of the barriers of diagnostic systems is not being flexible to accommodate diagnostics to networks including Layer 2 and Layer 3 networks. Typically, a message transmitted to perform diagnostics of the network is configured to be transmitted in a Layer 3 environment only, that is, between routers. However, conventional diagnostic mechanisms are unable to process diagnostics in a network including routers and switches. Accordingly, a diagnostic mechanism is needed that would be able to determine transmission problems in a network including both, switches (i.e., a Layer 2 network) and routers (i.e., a Layer 3 network).

### BRIEF DESCRIPTION OF THE DRAWINGS

Further embodiments, details, advantages and modifications of the present invention will become apparent from the following detailed description of the preferred embodiments which is to be taken in conjunction with the accompanying drawings, in which:

FIG. 1 illustrates a network configuration processing an extended ICMP message, in accordance with an embodiment of the present invention;

FIG. 2 illustrates an exemplary extended ICMP format, in accordance with an embodiment of the present invention; and

FIGS. 3A and 3B illustrate a diagnostic method performed using an extended ICMP message, in accordance with an embodiment of the present invention.

### DETAILED DESCRIPTION OF THE PREFERRED EMBODIMENTS

Reference will now be made in detail to the preferred embodiments of the present invention, examples of which are illustrated in the accompanying drawings. The embodiments of the present invention described below provides diagnostic mechanism allowing detection of transmission or congestion problems in a Layer 2 network and a Layer 3 network using an extended Internet Control Message Protocol (ICMP) including Media Access Control (MAC) header, Internet Protocol (IP) header, and an ICMP header.

Currently, internets, intranets, and similar public or private data networks that interconnect computers generally use packet switching technology. Packet switching provides for more efficient use of a communication channel than does circuit switching. Packet switched networks transport packets of information which can include various types of data such as, e.g., digitized voice, data, and video.

In addition, a packet can be one of various Ethernet packet types, such as Ethernet II. Inside the Ethernet packet can be an IP packet or another (potentially fragmented) Layer 2 frame (Ethernet II, 802.3, 802.11 etc.). Based on each type of packet, parsing logic inside an ingress stage can extract control information from a header of the packet. The header may contain the following fields: source and destination address, fragment payload size, fragment identity (Fragment ID), fragment payload offset, source and destination ports, if applicable, Class of Services (COS) of the packets, if applicable, and/or tunnel keys, if applicable.

Further, in a Layer 3 network, packet switching breaks a media stream into pieces known as, for example, packets, cells or frames. Each packet can then be encoded with address information for delivery to the proper destination and can be sent through the network. The packets can be received at the destination and the media stream is reassembled into its original form for delivery to the recipient. This process is made possible using an important family of communications protocols, commonly called the Internet Protocol (IP).

In a packet-switched network, there is no single, unbroken physical connection between sender and receiver. The packets from many different calls share network bandwidth with other transmissions. The packets can be sent over many different routes at the same time toward the destination, and can then be reassembled at the receiving end.

A data network can include a plurality of network routers. Network routers are used to route information between multiple networks. Routers act as an interface between two or more networks. Routers can find the best path between any two networks, even if there are several different networks between the two networks.

Network routers can include tables describing various network domains. A domain can be thought of as a local area network (LAN) or wide area network (WAN). Information can be transferred between a plurality of LANs and/or WANs via network routers. Routers look at a packet and determine from the destination address in the header of the packet, the destination domain of the packet. If the router is not directly connected to the destination domain, then the router can route the packet to the router's default router, i.e., a router higher in a hierarchy of routers. Because each router has a default router to which it is attached, a packet can be transmitted through a series of routers to the destination domain and to the destination host bearing the packet's final destination address.

Routing is done at the middle network architecture levels on such protocols as IPX or TCP/IP. Switching is done at a lower level, at Layer 2 of the OSI model, i.e., the media access control (MAC) layer.

Some networks are packet-centric networks. Unlike a circuit-centric network, a packet-centric network does not use dedicated circuits through which to transfer packets. TCP/IP performs a packetization of user data to be sent between and among the various systems on the IP network. When a large file is sent down the protocol stack, the IP function is responsible for segmentation and packetization of the data. Then, a header is placed on the packet for delivery to the data link. The routing and switching of this data is handled at the IP (i.e., network) layer. IP is in a sense a dumb protocol. When a packet is prepared for transmission across the medium, IP does not specifically route the call across a specific channel. Instead, it places a header on the packet and lets the network deal with it. Therefore, the outward bound packets can take various routes to get from a source to a destination. This means that the packets are in a datagram form and not sequentially numbered as they are in other protocols. IP makes its best attempt to deliver the packets to the destination network interface; but it makes no assurances that data will arrive, that data will be free of errors, and that nodes along the way will concern themselves with the accuracy of the data and sequencing, or come back and alert the originator that something is wrong in the delivery mechanism.

It is possible that in IP routing of a packet, the packet can be sent along the network in a loop, so IP has a mechanism in its header information to allow a certain number of “hops” or what is called “time to live” (TTL) on the network. Rather than permitting an undeliverable pack to loop around the network, IP may be set to include a counter mechanism that would decrement every time the packet passes through a network node.

Thus, IP header fields can include, for instance, source and destination IP addresses, IP type of service (TOS), IP time to live (TTL), and protocol fields. IP is a datagram protocol that is highly resilient to network failures, but does not guarantee sequence delivery. Routers send error and control messages to other routers using the Internet Control Message Protocol (ICMP). ICMP can also provide a function in which a user can send a “ping” (echo packet) to verify reachability and round trip delay of an IP-addressee host. Another OSI Layer 3 protocol is address resolution protocol (ARP) which can directly interface to the data link layer. ARP maps a physical address, for instance, an Ethernet MAC address (i.e., for a Layer 2 network), to an IP address (i.e., for a Layer 3 network).

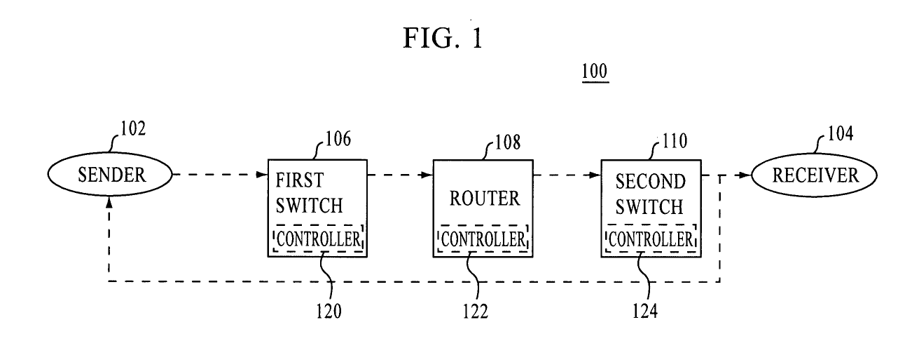

Referring to FIG. 1, this figure illustrates a representation of a network 100 in which a sender 102 is operatively connected to a receiver 104, in accordance with an embodiment of the present invention. The sender 102 and the receiver 104 communicate with one another over at least one communication path. Along that communication path are a first switch 106, a router 108, and a second switch 110 supporting communication between the sender 102 and the receiver 104. Although the path from the sender 102 to the receiver 104 is depicted as a single straight line, a person of ordinary skill in the art will appreciate that the actual physical topology of this path may vary and may be more complex.

Generally, a flow is defined as any communication between communicating entities identified by an IP address, a protocol and a service port. All data packets transmitted between the sender 102 and the receiver 104 may be categorized using fields present in the packets themselves: source/destination IP addresses, source/destination MAC addresses, the protocol indicated in the IP header PROTO field, and, in the case of UDP or TCP, by the packet's source and destination port numbers.

An Internet Control Message Protocol (ICMP) is designed to convey error event information back to the sender 102. The error event may include no routing path available, routing path is not operable, congestion detection, etc. However, in conventional systems, the ICMP message is limited to IP support when a router is in a “failed” state. In instances in which switches are provided in combination with the routers, in the conventional systems, the ICMP message cannot be utilized to monitor data packet transmission through the routers and generate the error event information associated with the routers. Current network systems need to be able to receive a feedback message indicate at which particular point in data transmission, that is, which router or switch is generating the delay. Rather than providing a diagnostic mechanism applicable to routers in Layer 3 protocol only, a diagnostic mechanism is provided in the present invention to be applied to both, routers in Layer 3 protocol and switches in Ethernet/Layer 2 protocol and configured to determine whether delays or errors are occurring either at a particular router or at a particular switch in a same network.

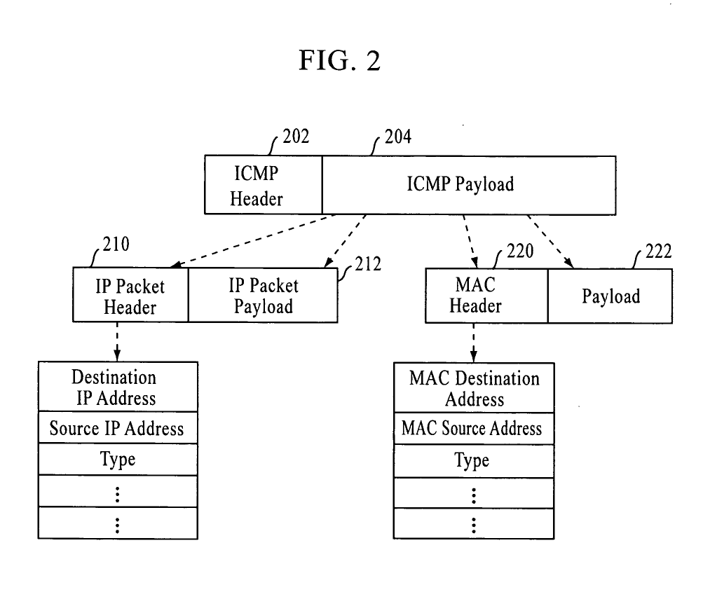

Referring to FIG. 2, this figure illustrates an exemplary extended ICMP format, in accordance with an embodiment of the present invention. The ICMP format includes an ICMP header 202 and an ICMP data field or payload 204. In accordance with an embodiment of the present invention, the ICMP payload may be extended to include IP packet data and MAC packet data.

The IP packet data includes an IP packet header 210 and an IP packet data field or payload 214. The IP packet header 210 may include a Protocol field for indicating the protocol of a message encapsulated therein. In an example, the protocol field would be set to indicate a protocol value corresponding to ICMP. The IP header may also include a destination IP address field, a source IP address field, a type filed for indicating a protocol associated with a message being carried, and other known fields (not shown).

The Ethernet/MAC packet data includes an Ethernet packet header 220 and a packet data field or payload 222. The Ethernet header may also include a destination MAC address field, a source MAC address field, a type filed for indicating a protocol associated with a message being carried, and other known fields (not shown). In an example, the type field would be set to indicate a type value corresponding to ICMP.

In accordance with an embodiment of the present invention, the ICMP message is expanded and configured so as to include a MAC address (i.e., MAC source and destination addresses) and an IP address (i.e., IP source and destination addresses). Thus, the ICMP message may be received, read, and processed by either a router (i.e., Layer 3) or a switch (i.e., Layer 2). As the ICMP message is transmitted through the routers and switches, the TTL associated with the ICMP message is decremented by a predetermined number, for instance, by one, as it goes through each switch and router.

As illustrated in FIG. 1, during diagnostics, the ICMP message would be transmitted from the sender 102 to the receiver 104. Although two switches and a router are provided in FIG. 1, a person of ordinary skill in the art will appreciate that different configurations may be provided between switches and routers and that the number of switches and routers between the sender 102 and the receiver 104 may vary depending upon a particular network configuration. Thus, the ICMP message is configured to be transmitted through the network 100 illustrated in FIG. 1 including the first switch 106, the router 108, and the second switch 110. Accordingly, the TTL for the ICMP message is configured during system initialization to be equal to three (TTL=3). As the ICMP message is transmitted through the first switch 106, the first switch 106 intercepts the ICMP message and sends it to a controller 120. Because the ICMP message has been extended to be able to hold MAC addresses and IP addresses, the controller 120 in the first switch 106 would add new information to be associated with the MAC address corresponding to the first switch 106, the information including diagnostic information pertaining to the first switch 106, such as no routing path available, routing path is not operable, or congestion detection.

The controller 120 in the first switch 106 would then inspect the TTL and decrement the TTL by the predetermined number (e.g., one) and determine whether the TTL is greater than zero, which indicates that at least one switch or router is remaining in the network scheduled to receive the extended ICMP message. In this instance, the controller 120 in the first switch 106 decrements TTL so that TTL is equal to two (TTL=2). Thus, because TTL is greater than zero, the ICMP message may be transmitted to a next node, which is the router 108.

The router 108 intercepts the ICMP message and sends it to a controller 122. The controller 122 in the router 108 adds new information to be associated with an IP address corresponding to the router 108, the information including diagnostic information pertaining to the router 108. The controller 122 in the router 108 would then inspect the TTL and decrement the TTL by the predetermined number (e.g., one) and determine whether TTL is still greater than zero; indicative that at least one router or router is remaining in the network scheduled to receive the ICMP message. In this instance, the controller 122 in the router 108 decrements TTL so that TTL is equal to one (TTL=1).

Thus, because TTL is greater than zero, the ICMP message may be transmitted to a next node, which is the second switch 110. As the ICMP message is transmitted through the second switch 110, the second switch 110 intercepts the ICMP message and sends it to a controller 124. The controller in the second switch 110 would add new information to be associated with a MAC address corresponding to the second switch 110, the information including diagnostic information pertaining to the second switch 110.

The controller 124 in the second switch 110 would then inspect the TTL and decrement the TTL by the predetermined number (e.g., one) and determine whether TTL is still greater than zero, indicative that at least one switch or router is remaining in the network scheduled to receive the ICMP message. In this instance, the controller 124 in the second switch 110 decrements TTL so that TTL is equal to zero (TTL=0). Thus, because TTL is equal to zero, the second switch 110 would then send the ICMP message back to the sender 102 for diagnostic determination.

In turn, the sender 102 would receive the ICMP message and extract therefrom the IP addresses associated with the first and second switches 106, 110 and the MAC address associated with the router 108. Based on the IP addresses and the corresponding added information, the sender 102 would be able to identify and determine which switch 106, 110 is experiencing congestion or transmission problems. Similarly, based on the MAC address and the added information, the sender 102 would be able to identify and determine whether the router 108 is experiencing congestion.

Therefore, the ICMP message is configured to be able to provide the sender 102 with the ability to identify the particular switch or router experiencing problems. The ICMP message is extended so as to be able to be read and processed in a Layer 2 or Layer 3 protocol.

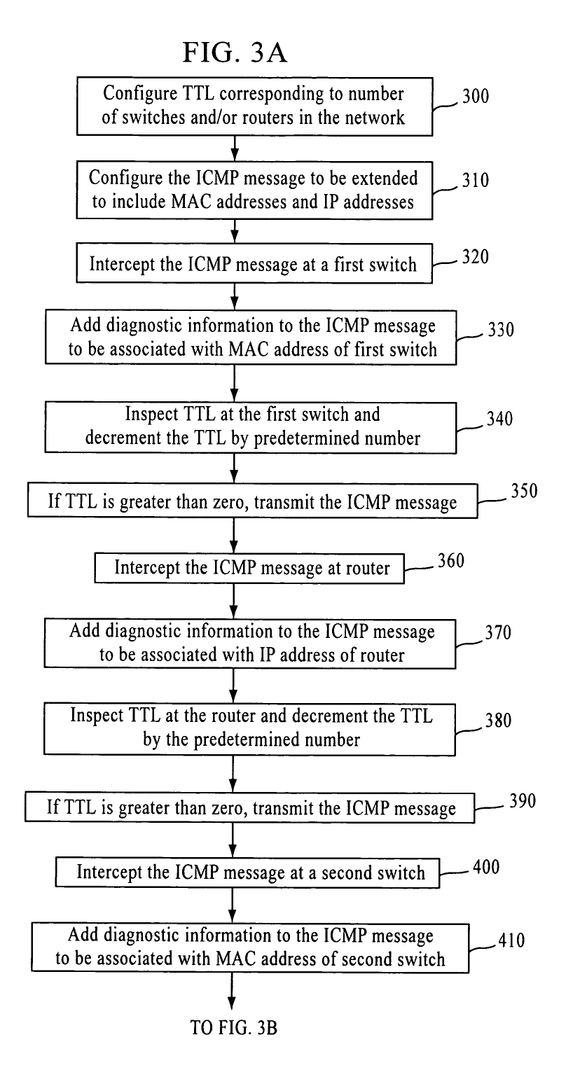

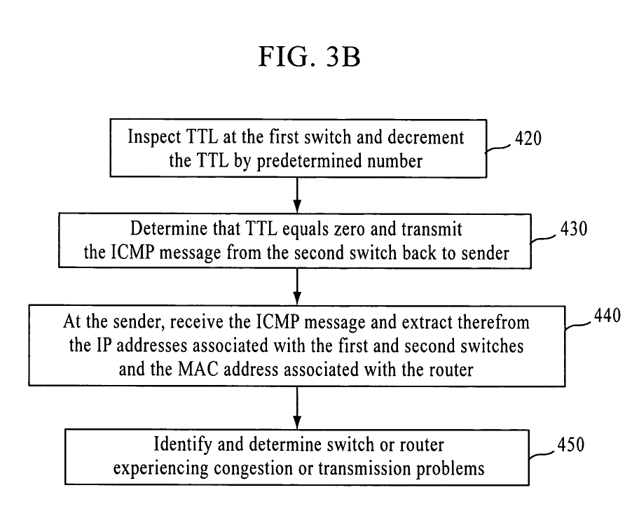

FIGS. 3A and 3B illustrate a diagnostic method performed using an extended ICMP message, in accordance with an embodiment of the present invention. The method of FIGS. 3A and 3B will be described with respect to the network configuration illustrated in FIG. 1. However, a person of ordinary skill in the art will appreciate that operations will vary depending upon the number of switches and/or routers provided in the network 100.

At operation 300, the method configures a time to live (TTL) field in a packet to be transmitted and initializing the TTL field to include an integer value greater than zero, that is, to correspond to the number of switches and/or routers in the network 100. At operation 310, the method configures the ICMP message to be extended to include MAC addresses and IP addresses corresponding to the switches and routers in the network 100.

At operation 320, the method intercepts the ICMP message at the first switch 106. At operation 330, the method adds new information (e.g., diagnostic information) to the ICMP message to be associated with the MAC address and corresponding to the first switch 106. At operation 340, the method inspects the TTL field at the first switch 106 and decrements the TTL field by the predetermined number (i.e., TTL=2). At operation 350, because TTL field is greater than zero, the method transmits the ICMP message to a next network node.

At operation 360, the method intercepts the ICMP message at the router 108. At operation 370, the method adds new information (e.g., diagnostic information) to the ICMP message to be associated with the IP address and corresponding to the router 108. At operation 380, the method inspects the TTL field at the router 108 and decrements the TTL field by the predetermined number (i.e., TTL=1). At operation 390, because TTL field is greater than zero, the method transmits the ICMP message to a next network node.

At operation 400, the method intercepts the ICMP message at the second switch 110. At operation 410, the method adds new information (e.g., diagnostic information) to the ICMP message to be associated with the MAC address and corresponding to the second switch 110. After operation 410 in FIG. 3A, the method proceeds to operation 420 in FIG. 3B. At operation 420, the method inspects the TTL field at the second switch 110 and decrements the TTL field by the predetermined number (i.e., TTL=0). At operation 430, because TTL field is equal to zero, the method transmits the ICMP message from the second switch 110 back to the sender 102 for diagnostic determination.

At operation 440, at the sender 102, the method receives the ICMP message and extracts therefrom the IP addresses associated with the first and second switches 106, 110 and the MAC address associated with the router 108. Based on the IP addresses and the corresponding added information, at operation 450, at the sender 102, the method identifies and determines which switch 106, 110 is experiencing congestion or transmission problems. Similarly, based on the MAC address and the added information, the method would be able to identify and determine whether the router 108 is experiencing congestion.

It is to be understood that in the embodiment of the present invention, the operations are performed in the sequence and manner as shown although the order of some operations and the like may be changed without departing from the spirit and scope of the present invention.

Each controller described above may include permanent or removable storage, such as magnetic and optical discs, RAM, ROM, etc. on which the process and data structures of the present invention can be stored and distributed.

With respect to the present invention, network devices may be any device that utilizes network data, and can include switches, routers, bridges, gateways or servers. In addition, while the terms packet and datagram have been used in the description of the present invention, the invention has import to many types of network data. For purposes of this invention, the term packet includes packet, cell, frame, datagram, bridge protocol data unit packet, packet data and any equivalents thereof.

Accordingly, the present invention allows for a diagnostic mechanism to be applied to switches and routers, that is, to Layer 2 and Layer 3 networks. An Internet Control Message Protocol (ICMP) is configured to be extended to include a MAC address and an IP address and to convey error event information pertaining to a switch or a router back to a sender of a diagnostic request.

The many features and advantages of the invention are apparent from the detailed specification and, thus, it is intended by the appended claims to cover all such features and advantages of the invention which fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed:

1. A diagnostic apparatus for a network, comprising:
a sender configuring a time to live (TTL) field in a packet to include an integer value greater than zero, configuring and extending an Internet Control Message Protocol (ICMP) message to include a Media Access Control (MAC) address and an Internet Protocol (IP) address, and transmitting the ICMP message;
a switch corresponding to the MAC address configured to add diagnostic information to the ICMP message; and
a router corresponding to the IP address configured to add diagnostic information to the ICMP message; and
a receiver configured to receive the packet.

2. The diagnostic apparatus as recited in claim 1, wherein the sender configures the TTL field to correspond to a number of switches and/or routers in the network.

3. The diagnostic apparatus as recited in claim 1, wherein the switch is further configured to intercept the ICMP message from the sender, add the diagnostic information to the ICMP message of the switch associated with the MAC address, inspect the TTL field at the switch, and decrement the TTL field by a predetermined number.

4. The diagnostic apparatus as recited in claim 3, wherein, when the TTL field is greater than zero, the switch is further configured to transmit the ICMP message to a next network node.

5. The diagnostic apparatus as recited in claim 4, wherein the router is further configured to intercept the ICMP message from the switch, add the diagnostic information to the ICMP message of the router associated with the IP address, inspect the TTL field at the router, and decrement the TTL field by the predetermined number.

6. The diagnostic apparatus as recited in claim 1, wherein, when the TTL field is equal to zero after decrementing the TTL field by a predetermined number at the router or at the switch, the ICMP message is transmitted back to the sender.

7. The diagnostic apparatus as recited in claim 6, wherein the sender is configured to receive the ICMP message, extract from the ICMP message the IP address and the diagnostic information associated with the switch, and extract from the ICMP message the MAC address and the diagnostic information associated with the router.

8. The diagnostic apparatus as recited in claim 7, wherein the sender is configured to identify and determine whether at least one of the switch and the route experiencing congestion or transmission problems.

9. A diagnostic apparatus for a network, comprising:
means for configuring a time to live (TTL) field in a packet to include an integer value greater than zero;
means for configuring and extending an Internet Control Message Protocol (ICMP) message to include a Media Access Control (MAC) address and an Internet Protocol (IP) address; and
means for transmitting the ICMP message from a sender to a receiver through a switch and a router.

10. A diagnostic method for a network, comprising:
configuring a time to live (TTL) field in a packet to include an integer value greater than zero;
configuring and extending an Internet Control Message Protocol (ICMP) message to include a Media Access Control (MAC) address and an Internet Protocol (IP) address; and
transmitting the ICMP message from a sender to a receiver through a switch and a router.

11. The diagnostic method as recited in claim 10, further comprising:
adding diagnostic information to the ICMP message of the switch associated with the MAC address; and
adding diagnostic information to the ICMP message of the router associated with the IP address.

12. The diagnostic method as recited in claim 10, further comprising:
configuring the TTL field to correspond to a number of switches and/or routers in the network.

13. The diagnostic method as recited in claim 10, further comprising:
intercepting at the switch the ICMP message transmitted from the sender;
adding diagnostic information to the ICMP message of the switch associated with the MAC address;
inspecting the TTL field at the switch; and
decrementing the TTL field by a predetermined number.

14. The diagnostic method as recited in claim 13, wherein, when the TTL field is greater than zero, further comprising
transmitting the ICMP message to a next network node.

15. The diagnostic method as recited in claim 14, further comprising:
intercepting at the router the ICMP message transmitted from the sender;
adding diagnostic information to the ICMP message of the router associated with the IP address;
inspecting the TTL field at the router; and
decrementing the TTL field by the predetermined number.

16. The diagnostic method as recited in claim 10, wherein, when the TTL field is equal to zero after decrementing the TTL field by a predetermined number at the router or at the switch, the diagnostic method further comprises:
transmitting the ICMP message including the diagnostic information of the switch and the router to the sender.

17. The diagnostic method as recited in claim 16, further comprising:
receiving the ICMP message at the sender; and
extracting from the ICMP message the IP address and the diagnostic information associated with the switch; and
extracting from the ICMP message the MAC address and the diagnostic information associated with the router.

18. The diagnostic method as recited in claim 17, further comprising:
identifying and determining whether at least one of the switch and the router experiencing congestion or transmission problems based on the diagnostic information of the sender and the router.

19. A computer program embodied within a computer readable medium, the computer program being configured to perform a diagnostic method for a network, comprising:
configuring a time to live (TTL) field in a packet to include an integer value greater than zero;
configuring and extending an Internet Control Message Protocol (ICMP) message to include a Media Access Control (MAC) address and an Internet Protocol (IP) address; and
transmitting the ICMP message from a sender to a receiver through a switch and a router.
